(19) United States
(12) Patent Application Publication
(10) Pub. No.: US 2013/0329166 A1
(43) Pub. Date: Dec. 12, 2013

(54) DECORATIVE PANEL

(71) Applicants: Assaf Poliakine, Jerusalem (IL); Amir Ben-Shalom, Modiin (IL); Christopher John Hughes, Reading (GB); David Coates, Wimbourne (GB)

(72) Inventors: Assaf Poliakine, Jerusalem (IL); Amir Ben-Shalom, Modiin (IL); Christopher John Hughes, Reading (GB); David Coates, Wimbourne (GB)

(73) Assignee: VERSATILE TECHNOLOGIES LTD, Neve Ilan (IL)

(21) Appl. No.: 13/884,656

(22) PCT Filed: Nov. 2, 2011
(86) PCT No.: PCT/GB2011/001555

§ 371 Date: Sep. 3, 2013

(30) Foreign Application Priority Data
Nov. 12, 2010 (GB) 1019213.6

(51) Int. Cl. G02F 1/01; G02F 1/13

(52) U.S. Cl. CPC G02F 1/0102; G02F 1/1313
USPC 349/84; 359/240; 359/245; 359/263

(57) ABSTRACT

A decorative panel (1) comprises a transparent front substrate (2) having a foreground image printed thereon, the foreground image having varying transparency across its area. Behind the foreground image, is at least one layer (3) of optically reflective or absorptive material which has a reflectance or absorptance that is changeable in response to an external stimulus and which transmits incident light that is not reflected or absorbed. Behind the at least on layer of reflective material, is a background layer (4) on which light transmitted by the at least one layer of optically reflective or absorptive material is incident and which is not transparent.

The present invention relates to a decorative panel.

A decorative panel (also referred to as a tile) is a type of decorative covering that is attached to interior and exterior surfaces, typically walls but also including other surfaces such as floors, ceilings and surfaces of objects including furniture and automobiles, to enhance their appearance. Such decorative coverings can enhance the environment, look beautiful and provide pleasure to the viewer. For example, a large industry is based on providing textured decorative coverings for buildings made from fabric, wood, ceramic and stone materials. Often such coverings are provided as tiles in various sizes to make them a manageable size for attachment to the surface to be covered. The present invention is concerned generally with technical means for making a decorative panel attractive.

In most common decorative coverings, the materials of the covering are passive. That is, their appearance does not change, once fixed to the surface to be covered, although they may have reflective properties that are dependent on viewing angle giving the appearance of change as the viewer moves.

Nonetheless, some decorative panels have been developed that can show a change in appearance, for example colour, in at least a small section of the panel. For example, there have been used to enhance walls active wall coverings including LEDs (Light Emitting Diodes) and video walls made from LCDs (liquid crystal displays). Such wall coverings are emissive and provide an image or appearance that can seem intrusive to a viewer.

According to the present invention, there is provided a decorative panel comprising:

a transparent front substrate having a foreground image printed thereon, the foreground image having varying transparency across its area;

behind the foreground image, at least one layer of optically reflective or absorptive material which has a reflectance or absorptance that is changeable in response to an external stimulus and which transmits incident light that is not reflected or absorbed;

behind the at least one layer of reflective material, a background layer on which light transmitted by the at least one layer of optically reflective or absorptive material is incident and which is not transparent.

The decorative panel has an overall appearance that is dependent in part on the foreground image. As that foreground image has varying transparency, some parts are transparent or partially transparent. Thus, the appearance of the panel in those parts, and hence the appearance of the panel as a whole, is affected by the at least one layer of reflective or absorptive material. Furthermore, the at least one layer of reflective or absorptive material has a reflectance or absorptance that is changeable. In this manner, the overall appearance of the panel as a whole is also changeable. The at least one layer of reflective material transmits incident light that is not reflected or absorbed. The transmitted light is incident on the background layer. Thus, the appearance of the panel is further affected by the background layer, that is in the parts of the panel where the foreground image is at least partially transparent and when in those parts the at least one layer of reflective material is at least partially transparent.

As a result of this construction, the decorative panel has an overall appearance that is dependent on the foreground image, the at least one layer of reflective or absorptive material, and the background layer. Furthermore, that overall appearance is changeable by means of the reflectance or absorptance of the at least one layer of reflective or absorptive material being changeable. In practice, this construction allows the panel to be designed with a range of unusual and surprisingly attractive and interesting appearances, that may be changed in use.

Furthermore, such changes may be provided in more subtle ways than changing the appearance of the entire decorative panel. If the appearance of the entire panel is changed, for example from white to blue, then the effect can be perceived as overpowering. However, the present decorative panel can produce a more subtle effect because the change is only perceived through the foreground image that has a varying transparency. For example, in panels where parts of the foreground image is not transparent, no change is perceived in those parts, and in panels where parts of the foreground image is partially transparent, the effect of the change is reduced or modulated in dependence on the amount of light transmitted therethrough. This capability makes the change and the decorative panel less intrusive. At the same time, it has been found that the changes can provide surprising and unique optical effects that may provide enjoyment and pleasure to the viewer, even when perceived over a small area or through a partially transparent part of the foreground image.

Although the present invention allows the panel to be provided with a range of appearances, it is not dependent on the aesthetic quality as such, aesthetics being of course subjective, but rather is concerned with the technical construction of the decorative panel that allows the appearance to be selected, thus providing the means to provide new designs at the creative control of the designer.

The foreground image has varying transparency across its area. This means it includes parts that are fully transparent and/or parts that are partially transparent. Advantageously, it includes parts having different partial transparency, as this allows a textured appearance to be provided. The foreground may in many cases include parts that are not transparent which can be advantageous in reducing the impact and intrusiveness of changes of appearance caused by the at least one layer of reflective material.

In one type of decorative panel, the foreground image has the appearance of stone or wood, but this is not limitative and the foreground image may take a variety of other forms, including having the appearance of other natural objects than stone or wood or being an image of a scene or object.

Advantageously, the foreground image is printed on the rear of the transparent front substrate. As well as protecting the foreground image physically, this allows the front of the transparent front substrate to be provided with an effect that improves the appearance of the panel, for example treated to reduce its reflectance or covered by an anti-reflection or anti-glare layer. However, the foreground image can alternatively be printed on the front of the transparent front substrate.

The at least one layer of reflective or absorptive material may be any type of material that has changeable reflectance or absorptance. It may be solely reflective or solely absorptive, or may be both reflective and absorptive, for example a material that scatters light.

In the case that the at least one layer of reflective or absorptive material is reflective material, the material may be cholesteric liquid crystal material but this is not limitative. Other reflective or absorptive materials may be used, for example but not exclusively, materials that have been developed for use in display devices.

The reflectance or absorptance spectrum of the reflective or absorptive material may be uniform but advantageously is non-uniform so that the light reflected thereby is coloured. In this latter case, the colour perceived by the viewer changes when the reflectance or absorptance changes. This allows the overall change in the appearance of the panel to include a change of colour.

The at least one layer of reflective or absorptive material may have reflectance or absorptance that are uniform across its area, or may have reflectance or absorptance that vary across its area.

The at least one layer of reflective or absorptive material may have areas that have reflective properties that are independently changeable in response to an external stimulus. This increases the degree to which the overall appearance can be changed. In some arrangements, it allows the decorative panel to have an appearance perceived as a moving pattern.

The reflectance or absorptance of the at least one layer of reflective or absorptive material may be changeable to more than two different levels, that may be discrete or continuous, thereby giving a series or range of grey levels.

The at least one layer of reflective or absorptive material may be changeable in response to a variety of types of external stimulus.

One possible external stimulus is an electrical signal. In this case, the change may be controlled by an electrical signal applied externally or from a control circuit that forms part of the panel.

Other possible types of external stimulus are heat or light. In that case, the appearance of the decorative panel may change automatically in response to its ambient environment.

The background layer is not transparent so that light incident on it through the at least one layer of reflective or absorptive material is absorbed or reflected. However, the background layer may have a variety of different properties selected to provide different effects in combination with the at least one layer of reflective material.

In the case that the at least one layer of reflective or absorptive material is reflective material, the background layer may have the following properties.

In one type of panel, the background layer is fully absorptive, thus appearing black or partially absorptive. In this case, changing the reflective material to have a high reflectance provides a bright state, and changing the reflective material to have a low reflectance provides a dark state.

In another type of panel, the background layer is at least partially reflective.

In one example, the background layer may be diffusively reflective with a non-uniform reflectance spectrum so that it appears coloured. In this way the colour perceived by the viewer arising from the combination of the at least one layer of reflective material and the background layer changes as the total reflectance of the at least one layer of reflective material changes.

In another example, the background layer may be specularly reflective, with a uniform or non-uniform reflectance spectrum. This can provide an interesting appearance that varies depending on the angle of incident light and the angle of view.

The background layer may have a uniform or varying reflectance or absorptance across its area.

In the case that the at least one layer of reflective or absorptive material is absorptive material, the background layer may be reflective. In this way, the background layer reflects light that is transmitted by the absorptive material. In this case, changing the absorptive material to have a low absorptance provides a bright state by reflection from the background layer, and changing the absorptive material to have a high absorptance provides a dark state.

To allow better understanding, embodiments of the present invention will now be described by way of non-limitative example with reference to the accompanying drawings, in which:

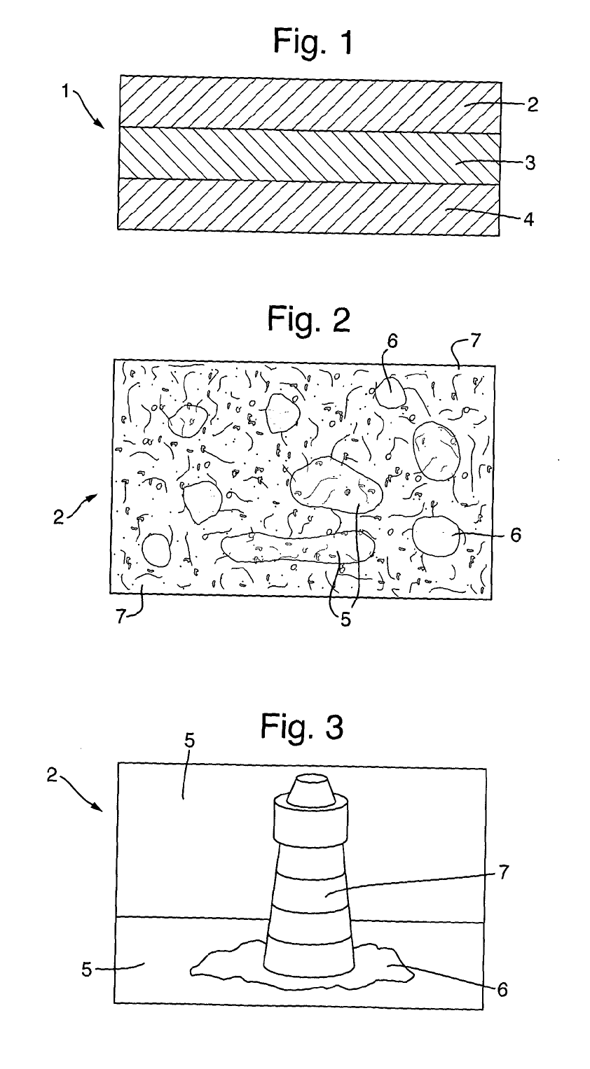

FIG. 1 is a cross-sectional view of a decorative panel;

FIG. 2 is a front view of a foreground image carried by the transparent front substrate of the decorative panel;

FIG. 3 is a front view of an alternative foreground image;

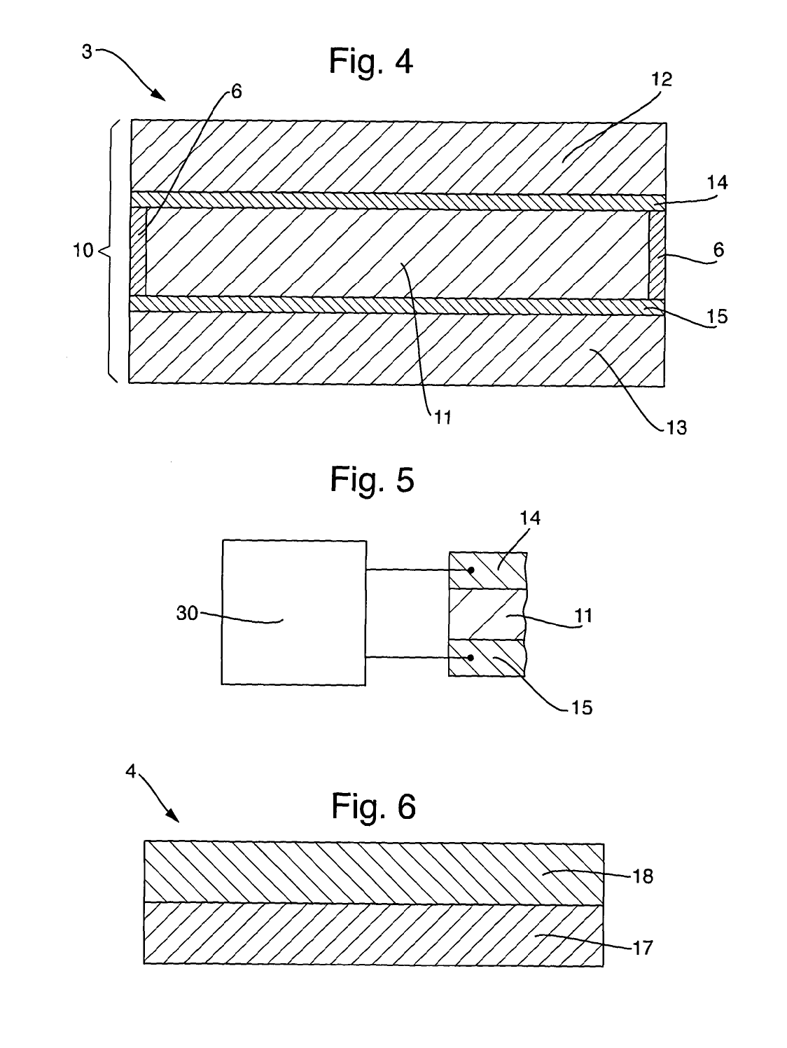

FIG. 4 is a cross-sectional view of a reflective display device of the decorative panel;

FIG. 5 is a diagram of a control circuit for the reflective display device;

FIG. 6 is a cross-sectional view of a possible form of a background layer of the decorative panel;

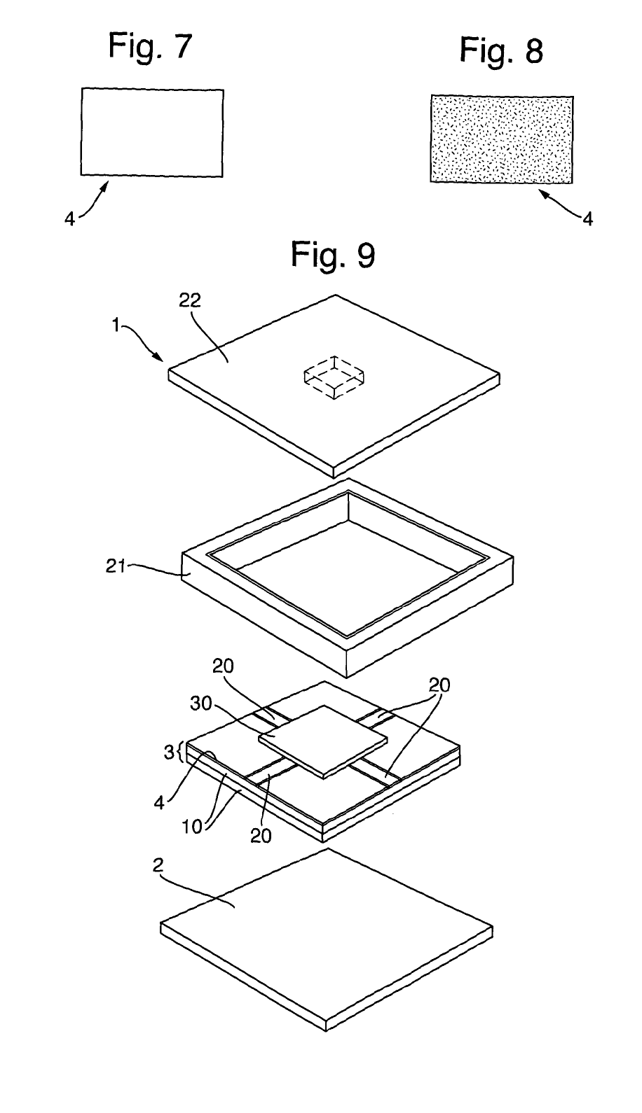

FIG. 7 is a front view of a possible background layer;

FIG. 8 is a front view of an alternative background layer;

FIG. 9 is an exploded, perspective view of a possible construction of the decorative panel; and

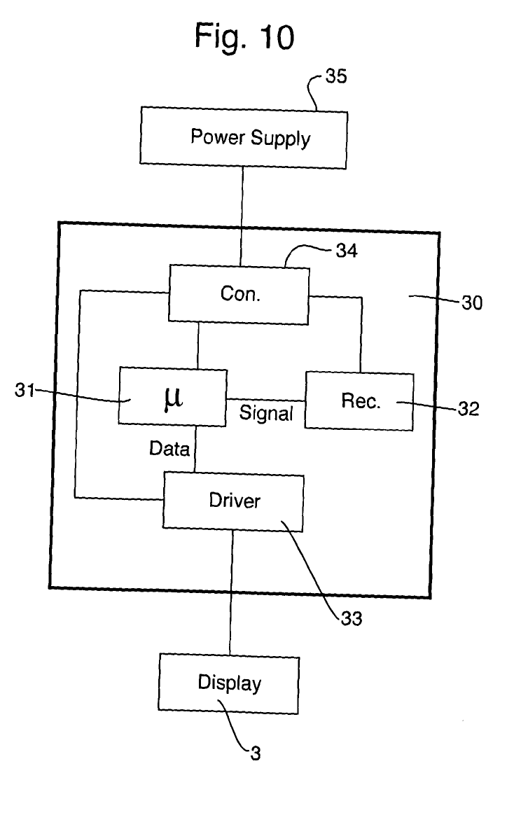

FIG. 10 is a block diagram of a possible implementation of the control circuit.

A decorative panel 1 is shown schematically in FIG. 1 and has a layered construction consisting of a transparent front substrate 2, a reflective display device 3 and a background layer 4 that are described further below and that are shown in FIG. 1 with a thickness that is exaggerated for clarity. The front of the decorative panel 1 from which it is viewed in normal use is uppermost in FIG. 1 so that the reflective display device 3 is behind the transparent front substrate 2 and the background layer 4 is behind the reflective display device 3. The decorative panel 1 may be rigid or flexible, according to the desired application.

First, the transparent front substrate 2 will be described. The transparent front substrate 2 carries a foreground image. The transparent front substrate 2 is ideally fully transparent as it is primarily a carrier for the foreground image, but this is not essential and it may have some degree of absorption provided that the layers below are not obscured.

The transparent front substrate 2 may be made from any suitable material, such as glass or plastic. It may be a single sheet or may comprise plural laminated sheets. Glass is suitable for a rigid decorative panel 1. Plastic is suitable for a rigid or flexible decorative panel 1.

In the case that the transparent front substrate 2 is made from glass, various types of glass can be used, for example ranging from soda glass to clear glass. If the transparent front substrate 2 is made of glass, for many applications, for example in buildings, it is desirable to be ‘safety glass’ meeting health and safety regulations, for example breaking into small harmless pieces (as does thermally toughened glass) or if breaking into sharp pieces (as does chemically toughened glass) bonded together after breaking, for example by lamination.

The transparent front substrate 2 may have any suitable thickness. The front substrate 2 is preferably as thin as possible, especially where the foreground image (described below) is on the rear surface and so the front surface may be visible above it, as may particularly be the case when the front surface is treated or coated (described below). For example, the thickness is preferably at most 2 mm, typically around 1 mm. In other embodiments, the thickness of the transparent front substrate 2 may be for example at least 2 mm, typically at least 3 mm and/or at most 12 mm, typically at most 6 mm. The thickness of the transparent front surface 2 is also chosen to provide sufficient strength and toughness, for rigidity and for protection.

Heat toughened glass is typically at least 3 mm thick and breaks into small harmless glass pieces. It can be safety glass. However, in some cases thinner front glass may be required in which case chemically toughened glass (which is typically 0.5-3 mm thick) can be used but as this type of glass breaks into large sharp chards, two or more sheets of it are usually laminated together, e.g. using polyvinyl butyral (PVB), such that it then becomes a safety glass. For example, two sheets of glass of thickness 1 mm provide a laminated front glass of thickness 2 mm.

The front surface of the transparent front substrate 2 may optionally be provided with an effect to improve the appearance of the decorative panel 1.

In one example, the front surface of the transparent front substrate 2 may be treated, for example etched or blasted, to provide an anti-glare effect and/or reduce its reflectance, thereby providing a softer and less reflective finish more like stone.

In an alternative example, an additional layer is applied to the front surface of the transparent front substrate 2, for example a layer that provides an anti-glare effect, an anti-reflection effect, or a combination thereof. Such a layer may be of any suitable material such as glass and can be applied in any suitable way such as bonding or lamination.

The transparent front substrate 2 may be coloured, for example by incorporating a dye, or may carry a coloured filter.

The foreground image may conveniently be printed on the transparent front substrate 2, although it could be carried in other ways for example incorporated into the transparent front substrate 2. For the case of printing, a range of suitable printing techniques and inks are available for use. Typically, the printing technique might be a digital printing technique, for example using an ink-jet printer for example an ultraviolet cure ink-jet printer. Advantageously, the printing resolution is at least 300 pdi.

For example, where the transparent front substrate 2 is made from glass, the following printing techniques are possible.

In one technique, there are used ceramic (inorganic) inks based on the CYMK system and specifically designed for use on glass. The act of firing the print onto the glass (at 600° C. to 1600° C.) causes the ink to fuse into the glass and give a very stable print. The high temperature heat cure can also in situ provide tempered glass. This process may be used on glass typically of 3 mm thickness or greater. These inks are sometimes opaque and sometimes partially transmissive.

In another technique, there are used inks that cure by UV light. The glass is not then automatically tempered because the glass is not heated. These inks are available in a wider colour range and contain transparent as well as opaque inks. This process can be carried out on an ordinary glass, pre heat-toughened glass (typically at least 3 mm thickness) or pre chemically-toughened glass (typically at most 3 mm thickness).

In another technique, there are used organic based inks that cure at less than 200° C. are also available and can be used in the same way as UV cured inks.

After printing, a transparent front substrate 2 made of glass can be laminated to another layer such as glass to protect the print or strengthen (laminated glass) the glass if it has not been tempered during this process. The lamination can also contain UV blockers to protect the underlying layers.

Printing may also be performed onto a plastic sheet (i.e. not glass). Then, the plastic sheet may be laminated either to the rear of the front glass or between two sheets of glass (i.e. if laminated glass is used) or indeed onto the front of the front glass.

Advantageously, the foreground image is printed on the rear of the transparent front substrate 2, or in the case that the transparent front substrate 2 comprises plural sheets, on an internal surface of one of the sheets. This makes it easier to provide the front of the transparent front substrate 2 with an effect to improve the appearance of the decorative panel 1, if that is desired. This also protects the foreground image physically because it is inside the decorative panel 1, possibly avoiding the need to apply an additional protective layer. That being said it remains possible to print the foreground image on the front of the transparent front substrate 2, even if that surface is treated.

The nature of the foreground image will now be discussed. The foreground image is passive, static and non-changing and has varying transparency across its area. This means it includes parts that are at least partially transparent, and may in some types of embodiment include parts that are fully transparent. The lower elements, in particular the reflective display device 3 and the background layer 4 are visible through these parts. The perception of the lower elements is complete at any parts that are fully transparent, but is modulated by the foreground image at any parts that are partially transparent. This effect may be used to vary the impact of the lower elements across the area of the decorative panel 1. Effectively, the foreground image being partially transparent can be used to provide grey levels in the appearance of the lower elements. Advantageously, the foreground image includes parts having different partial transparency, as this allows a textured appearance to be provided.

The foreground image may in many cases include parts that are not transparent which can be advantageous in reducing the impact and intrusiveness of changes of appearance caused by the at least one layer of reflective material. Such parts that are not transparent will typically be absorptive but could alternatively be reflective.

However, the precise nature of the foreground image, in particular what it is an image of, may be varied at the choice of the designer to provide a desired decorative effect.

In one type of decorative panel 1, the foreground image has the appearance of a natural material such as stone or wood. This appearance may be that of an actual type of natural stone or wood or artificial stone, or simply may be simulated to give the appearance of stone or wood. For example, in the case of stone it might have the appearance of marble, granite, limestone, onyx, slate, sandstone, Travertine, or quartzite, or any other stone for use as a panel. Such materials are generally in themselves are difficult to combine with material whose appearance is changeable, so are advantageous appearance for the foreground image in the decorative panel 1. In recent years, advances in digital printing and the availability of inks that can be printed onto glass or other substrates to give good colours and stable prints has made possible realistic prints that look like stone, for example when viewed through the transparent front substrate 2. Where the transparent front substrate 2 is made of glass, the natural reflectivity can give the decorative panel 1 an enhanced appearance of polished stone. Similarly, the provision of an effect on front of the transparent front substrate 2 can give the decorative panel 1 an enhanced appearance of stone having other finishes, for example a brushed, honed or satin finish, or of natural (i.e. unfinished) stone.

For example, FIG. 2 illustrates a possible foreground image on the transparent front substrate 2 having the appearance of natural stone, in this example including parts 5 that are not transparent, parts 6 that are partially transparent, and parts 7 that are fully transparent.

However, the foreground image having the appearance of stone is not limitative and the foreground image may take a variety of other forms, including an image having the appearance of other natural objects than stone, geometric patterns, or an image of a scene (e.g. seascapes, landscapes and the like) or an object.

For example, FIG. 3 illustrates a possible foreground image on the transparent front substrate 2 that is an image of a scene including a lighthouse, in this example including parts 5 that are not transparent (e.g. the sea and sky), parts 6 that are partially transparent (e.g. the rocks on which the lighthouse stands), and parts 7 that are fully transparent (e.g. the walls of the lighthouse).

Next, the reflective display device 3 will be described. There is first described an example in which the reflective display device 3 provides at least one layer of reflective material having a reflectance that is changeable in response to an external stimulus, that may be perceived through the parts of the foreground image that are fully or partially transparent. Various suitable reflective materials that change colour under the influence of an external stimulus are well known and may be applied.

One possible reflective material is cholesteric liquid crystal material. FIG. 4 illustrates a possible construction using cholesteric liquid crystal material and arranged as follows.

The reflective display device 3 comprises a single cell 10 incorporating a liquid crystal layer 11 of cholesteric liquid crystal material. The liquid crystal layer 11 is supported by two display substrates 12 and 13 arranged on opposite sides of the liquid crystal layer 11 to define therebetween a cavity in which the liquid crystal layer 11 is contained. The display substrates 12 and 13 are sufficiently rigid to support the liquid crystal layer 11, although they may have a degree of flexibility. For example, the display substrates 12 and 13 may be made of glass or plastic, plastic being preferred when the decorative panel 1 is flexible.

For a flexible decorative panel 1, the display substrates 12 and 13 are themselves made flexible for example as a thin film. In some cases, the liquid crystal layer is formed as a PDLC (described below) in which case it is possible that only one of the display substrates 12 or 13 is used, even though two electrode layers 14 and 15 (described below) remain present. In other cases, the display substrates 12 and 13 may be formed with ribs or provided with intermediate spacer elements to maintain a gap for the liquid crystal layer, for example as disclosed in Hashimoto et al., SID Digest of Tech Papers 29, 31.1, 1998.

The liquid crystal layer 11 may be sealed in the cavity between the display substrates 12 and 13 by providing a peripheral seal 16, for example of glue, around the periphery of the liquid crystal layer 11. In this case, the foreground image may be designed so that the parts of the foreground image aligned with the peripheral seal are opaque (i.e. not transparent, whether by being absorptive or reflective or a combination thereof), so that the peripheral seal 16 is not visible.

Electrode layers 14 and 15 are disposed on the respective display substrates 12 and 13, in particular on the inner facing surfaces of the display substrates 12 and 13 between those display substrates 12 and 13 and the liquid crystal layer 11. The electrode layers 14 and 15 are transparent and conductive, being formed of a suitable transparent conductive material, typically indium tin oxide. As described further below, the electrode layers 14 and 15 may extend across part or all of the area of the reflective display device 3, and may be patterned to provide separate pixels.

Optionally, the electrode layers 14 and 15 may be overcoated, on the side adjacent to the liquid crystal layer 11, by one or more insulation layers (not shown), for example made of silicon dioxide.

Additionally or alternatively, the electrode layers 14 or 15 may be covered by respective alignment layers (not shown) formed adjacent to the liquid crystal layer 11 and covering the electrode layers 14 and 15 or the insulation layers if provided. Such alignment layers align and stabilise the liquid crystal layer and may typically be made of polyimide which may optionally be unidirectionally rubbed. As an alternative to such surface-stabilisation using alignment layers, the liquid crystal layer could be bulk-stabilised, for example using a polymer or a silica particle matrix.

The liquid crystal layer 11 has a thickness chosen to provide sufficient reflection of light, typically being in the range from 3 μm to 10 μm. This thickness is selected by controlling the thickness between the display substrates 12 and 13, typically by the provision of spacers (not shown) within the liquid crystal layer 11.

The liquid crystal layer 11 comprises cholesteric liquid crystal material. The liquid crystal layer 11 may have a variety of forms that are known in themselves for display devices.

In one form, the liquid crystal layer 11 comprises a polymer dispersed liquid crystal (PDLC), for example comprising droplets of cholesteric liquid crystal dispersed in a polymer matrix. Formation of the liquid crystal layer 11 as a PDLC is particularly suitable to form a flexible decorative panel 1 in which the display substrates 12 and 13 are flexible. Such droplets may be micro-droplets, typically having a diameter of the order of 5 μm to 7 μm.

In one technique, a PDLC is formed as follows. The droplets may be encapsulated in a polymer film. The droplets may be coated as a water emulsion onto one of the display substrates 12 or 13 which may be a flexible film. The water is then driven off to leave a film of droplets, onto which a conductive layer and substrate are added. In that case, the other one of the display substrates 12 or 13 may be omitted. Further details which may be applied are disclosed in U.S. Pat. No. 3,600,060, U.S. Pat. No. 6,423,368 and SID Digest of Tech Papers 35, 774, 2004.

In another technique, a PDLC is formed as follows. The liquid crystal layer 11 is formed by in situ polymerising of a reactive material dissolved in a liquid crystal, for example using UV light, to form a polymer network structure. Further details which may be applied are disclosed in SID Digest of Tech Papers 36, 1568, 2004.

Cholesteric liquid crystal material has several physical states in which the reflectivity and transmissivity vary. These states are the planar state, the focal conic state and the homeotropic (pseudo nematic) state, as described in I. Sage, Liquid Crystals Applications and Uses, Editor B Bahadur, Vol. 3, 1992, World Scientific, pp 301-343 which is incorporated herein by reference and the teachings of which may be applied to the present invention.

In the planar state, the liquid crystal layer 11 selectively reflects a bandwidth of light that is incident upon it. The reflectance spectrum of the liquid crystal layer 11 in the planar state typically has a central band of wavelengths in which the reflectance of light is substantially constant.

The wavelength λ of the reflected light are given by Bragg's law, i.e. λ=nP·cos θ, where n is the mean refractive index of the liquid crystal material seen by the light, P is the pitch length of the liquid crystal material and θ is the angle from normal incidence. Thus, in principle, any colour can be reflected as a design choice by selection of the properties of the of the liquid crystal material, in particular the pitch length P. That being said, a number of further factors known to the skilled person may be taken into account to determine the exact colour.

The planar state is used as the bright state of the reflective display device 3 and the viewer sees the light reflected from the liquid crystal layer 11. When the liquid crystal material is in the planar state, light not reflected from the liquid crystal layer 11 is incident on the background layer 4. The background layer 4 is described further below, but if the background layer 4 is entirely absorptive (i.e. black), it absorbs substantially all the light incident thereon and the viewer sees just the light reflected from the liquid crystal layer 11. Similarly, if the background layer 4 is diffusively reflective with a non-uniform reflectance spectrum (i.e. coloured), it absorbs light incident light of some wavelengths but reflects light of other wavelengths. The light reflected from the background layer 4 is seen by the viewer in addition to the light reflected from the liquid crystal layer 11 and may change the perceived colour.

In the focal conic state, the liquid crystal layer 11 is, relative to the planar state, transmissive and transmits incident light. Strictly speaking, the liquid crystal layer 11 is mildly light scattering with a small reflectance, typically of the order of 1% or less. All the incident light is incident on the background layer 4 which may absorb at least some of the incident light. When the liquid crystal layer 11 is in the focal conic state, the viewer sees any light reflected from the background layer 4 and thus perceives the reflective display device 3 as being of the colour of the background layer 4, this being a darker state than when the liquid crystal layer 11 is in the planar state.

The focal conic and planar states are stable states which can coexist when no drive signal is applied to the liquid crystal layer 11. Furthermore the liquid crystal layer 11 can exist in stable states in which different domains of the liquid crystal material are each in a respective one of the focal conic state and the planar state. These are sometimes referred to as mixture states. In these mixture states, the liquid crystal material has a reflectance intermediate the reflectances of the focal conic and planar states. A range of such stable states is possible with different mixtures of the amount of liquid crystal in each of the focal conic and planar states so that the overall reflectance of the liquid crystal material varies, thus giving more than two different levels and in general a range of grey levels, although these are not necessarily used.

The focal conic, planar and mixed states are stable states that persist after the drive signal is removed. Thus the drive signal need only be applied to drive the liquid crystal layer 11 into one of the stable states. Thus, use of the stable states provides the reflective display device 3 with a low power consumption.

In the homeotropic state, the liquid crystal layer 11 is even more transmissive than in the focal conic state, typically having a reflectance of the order of 0.6% or less. However, the homeotropic state is not stable and so maintenance of the homeotropic state would require continued application of a drive signal. To reduce power consumption, the planar state, rather than the homeotropic state, is preferably used as the persistent bright state, although the liquid crystal may pass through the homeotropic state when driven into the planar and/or focal conic state, depending on the drive scheme used for the drive signals applied to the electrode layers 14 and 15.

The liquid crystal layer 11 also shows a slightly different colour, dependent on the angle of view. This effect can be controlled by controlling the alignment, for example using different aligning agents, in order to add interest to the overall appearance.

As an alternative to being formed by a single cell 10, the reflective display device 3 may comprise plural cells 10, each constructed as described above, stacked together in series. In this case each cell 10 may include a liquid crystal layer 11 that reflects a different part of the spectrum, so as to increase the colour gamut of the reflective display device 3.

Cholesteric liquid crystal material is an example of a reflective material that has total reflectance that is changeable in response to an external stimulus in the form of an electrical signal. Thus, the reflectance may be changed by supply of such an electrical signal. The electrical signal may be supplied externally or from a control circuit that forms part of the decorative panel 1. As an example of this FIG. 5 illustrates the case where the decorative panel 1 comprises a control circuit 30 connected across the electrode layers 14 and 15 on opposite side of the liquid crystal layer 11 (the other layers of the reflective display device 3 being omitted in FIG. 5 for clarity). The control circuit 30 is arranged to generate drive signals for changing the state of the liquid crystal layer 11. Many different forms of drive signal are known for changing the state of cholesteric liquid crystal material and any such form of drive signal may be used herein. The drive signal may be designed to drive the liquid crystal layer into any number of states, in some cases just two states (i.e. a bright and a dark state) and in some cases three or more states (i.e. to provide grey levels), up to a continuous range of states. Typically schemes might provide 8 to 20 states of different reflectance.

Some examples of suitable drive schemes are disclosed in Wu & Yang, “Reflective Liquid Crystal Displays”, Chapter 8, J Wiley & Sons, 2002.

The above described example of the reflective material being cholesteric liquid crystal material is not limitative and in general the reflective material may alternatively be any other reflective material that has a reflectance that is changeable in response to an external stimulus, or may be an absorptive material that has an absorptance that is changeable in response to an external stimulus. With these alternative materials, the reflective display device 3 may have essentially the construction shown in FIG. 4 but replacing the liquid crystal layer 11. Even in the case of using an absorptive layer, the reflective display device 3 is still correctly termed ‘reflective’ because there will be reflection from the background layer 4 described below.

In general, the change in the reflectance or absorptance may be a change in the total reflectance or absorptance and/or a change in the reflectance or absorptance spectrum.

The external stimulus that changes the reflective properties may be an electrical signal or another type of external stimulus such as heat or light. The benefit of the stimulus being an electrical signal is that it is possible to control the change. The benefit of the stimulus being heat or light is that the change occurs automatically in response to the ambient environment.

Some examples of alternative reflective materials that may be applied are as follows.

The reflective material may be a material that uses interference effects to selectively reflect wavebands of light. This type of material is not bistable.

The reflective material may be a material that reflects light by scattering. In this case, some of the light may be scattered towards the rear of the reflective display device. For example, the reflective material may be a smectic scattering material that provides a white scattering and a black background which with colour filters can provide bistable reflective colours.

The reflective material may be of the type disclosed in US-2002/0167004 and US-2008/0224131 utilising an effect referred to as ‘molecular-mechanical motion’ for example reversible zipping and unzipping of molecules that to provide entities that exhibit different colours.

Some examples of alternative absorptive materials that may be applied are as follows. The absorptive material may be an electric-wetting material whose coloured liquid can be made to move in and out of visible areas under the application of an applied field. Some of these devices can be bistable. This type of device is disclosed in Philips SID 2009 p480.

The absorptive material may be a thermo-chromic material such as a film of leuco dyes or monomeric and polymeric cholesteric liquid crystals that change colour when their temperature is changed. The colour change is reversible but is not bistable, once the energy source is removed the colour changes back to its original colour.

The absorptive material may be a photo-chromic material that changes colour when irradiated with UV or short wavelength visible light. The colour change is transitory so requires almost constant power to retain the colour of the excited state.

The absorptive material may be an electro-chromic material that changes colour when an electric field is applied, usually dark blue to white but colours can be provided using colour filters. This type of material is bistable. This type of device is disclosed in Samsung SID 2008 p1826.

Further possible properties of the reflective or absorptive layer, corresponding to the liquid crystal layer 11 in the above device, are as follows.

The reflective or absorptive layer may have reflective properties that are uniform across its area. However, additional decorative effects can be achieved if the reflective layer has reflective properties that are non-uniform across its area.

In one type of reflective display device 3, the reflectance or absorptance may be varied but subject to uniform change in response to an external stimulus. For example in the reflective display device 3 described above, this may be achieved by subdividing the liquid crystal layer 11 into parts of different cholesteric liquid material having different reflectance, for example reflecting light of different colours.

In another type of reflective display device 3, the layer of reflective or absorptive material may have areas that have reflective properties that are independently changeable in response to an external stimulus. For example in the reflective display device 3 described above, this may be achieved by arranging the electrode layers 14 and 15 to allow different areas of the liquid crystal material to be independently controlled, for example by subdividing one of the electrode layers 14 or 15 into separate electrodes.

The areas may in general be designed to have any size and shape to provide any desired appearance. Such areas may be independently controlled to provide any desired effect, for example by the drive signals from the control circuit 30 in the reflective display device 3 described above. One possibility is that the areas may be controlled to change their reflective properties in a manner that appears as a wave moving over the decorative panel 1. For example, the areas could be a number of stripes, e.g. three to eight stripes, showing successively lower grey levels that are cycled over a period of time to show apparent movement across the decorative panel 1. This can give the effect of increasing and decreasing colour rolling over the decorative panel 1 from one side to the other. Of course different reflectance or absorptance values can be chosen and the invention is not limited in this respect. The period of the movement can be automatically set or controlled by the user. Ideally, the change is sufficiently slow that the wave-like effect is gradual and subtle, for example changing over a period of at least 10 s, or even up to 5 minutes.

In the decorative panel 1 shown in FIG. 1, the transparent front substrate 2 is an additional substrate to the display substrates 12 and 13 of the reflective display device 3. This is advantageous in manufacture as the transparent front substrate and the reflective display device 3 can be separately made and then affixed together. However, as an alternative, the transparent front substrate 2 can constitute the front display substrate 12 of the reflective display device 3. In this case, either the foreground image is printed on the front of the transparent front substrate 2 and may need some form of physical protection, or else the foreground image is printed on the rear of the transparent front substrate 2 and may need to be planarised, for example by application of additional layers, to allow formation of the electrode layer 14.

Next, there will be described the background layer 4. The background layer 4 is not transparent so that it selectively absorbs and/or reflects any light passing through the reflective display device 3. Thus the light perceived by the viewer results from the combined effect of reflective display device 3 and the background layer 4 combine. For example, the background layer 4 may create different shades or colours for the background and/or influence the colour of the reflective or absorptive material by adding a second reflective colour. The background layer 4 may be a layer affixed directly to the rear of the reflective display device 3, for example a layer of paint or a layer of material bonded to the background layer 4. Alternatively, the background layer 4 may be formed separately and mounted behind reflective display device 3. In this case, the background layer 4 may optionally be formed on a substrate, made of any suitable material such as glass.

There are several options for the background layer 4 that may be selected by the designer to control the appearance of the decorative panel 1. Some examples when using reflective material in the reflective display device 3 are as follows.

The background layer 4 may be fully absorptive (i.e. black), so that it absorbs substantially all the light incident thereon. In this case, the viewer sees just the light reflected from the reflective layer. This is a common choice in a reflective display device for use as a display screen employing cholesteric liquid crystal material. In this case, changing the reflective material to have a high reflectance provides a bright state, and changing the reflective material to have a low reflectance provides a dark state. For example, a layer of cholesteric liquid crystal material that selectively reflects green light can be switched between a planar state where it is perceived as green and a focal conic state where it is perceived as black. A range of intermediate stable grey levels can also be provided between these two extreme stable states.

The background layer 4 may be diffusively reflective with a non-uniform reflectance spectrum (i.e. coloured), so that it absorbs incident light of some wavelengths (i.e. remains partially absorptive) but reflects light of other wavelengths. The light reflected from the background layer 4 is seen by the viewer in addition to the light reflected from the liquid crystal layer 11 and may change the perceived colour. This is known in itself for a reflective display device employing cholesteric liquid crystal material for use as a display screen. For example, a layer of cholesteric liquid crystal material that selectively reflects yellow light in front of a background layer 4 that reflects blue light can be switched between a planar state where it is perceived as white and a focal conic state where it is perceived as blue. Other colour combinations are also possible such as red background and green liquid crystal provides red and yellow reflective colours.

The background layer 4 may be specularly reflective. This is known in itself for a reflective display device for use as a display screen employing cholesteric liquid crystal material, as disclosed for example in U.S. Pat. No. 6,950,157. The background layer 4 may have any suitable construction or material. By way of example, the reflective layer may be a foil of metal, for example aluminium.

In this case, the background layer 4 may optionally comprise a reflective layer 17 behind a coloured filter layer 18. The filter layer 18 provides a coloured filter. In particular, the filter layer 18 may be arranged to have a relatively greater absorption of light of wavelength that are reflected by the reflective display device 3 than of light of other wavelengths. Ideally, the filter layer 18 would absorb an identical spectrum of wavelengths to the spectrum of wavelengths reflected by the liquid crystal material in its planar state. This ideal can be achieved approximately by selection of pigments for inclusion in the filter layer 18, but is difficult to achieve precisely.

The purpose of the background layer 4 comprising a reflective layer 17 behind a coloured filter layer 18 is to increase the brightness of the reflective display device 3 in both the bright and dark states. This is because light of wavelengths that are not reflected by the reflective display device 3 is transmitted through the reflective display device 3 and the filter layer 18, and reflected by the reflective layer 17, irrespective of the state of the reflective display device 3. Thus, in any state of the reflective display device 3, some light is reflected, in particular in that part of the spectrum which is not reflected by the reflective display device 3 in its reflective state.

The choice of the filter characteristic of the filter layer 18 with respect to the reflectivity of the reflective display device 3 means that the bright state when the reflective display device 3 is in the reflective state is perceived by the viewer as being predominantly white. This is because the light that is not reflected by the reflective display device 3 is transmitted through the filter layer 18 and reflected by the reflective layer 17. To the extent that the filter characteristic of the filter layer 18 does not match the reflection of the reflective display device 3, the viewer might perceive the colour to be off-white.

In contrast, in the dark state in which the reflective display device 3 is in the non-reflective state, all the light passes through the reflective display device 3, and the filter layer 18 absorbs light of some wavelengths but passes light of other wavelengths. The choice of the filter characteristic of the filter layer 18 means that the light transmitted by the filter layer 18 and reflected by the reflective layer 17 is of a colour that is complimentary to the colour reflected by the reflective display device 3. This effect is described in further detail in U.S. Pat. No. 6,950,157.

Some examples when using absorptive material in the reflective display device 3 are as follows.

The background layer 4 may be reflective, preferably diffusively reflective. In this way, the background layer reflects light that is transmitted by the absorptive material without being absorbed. In this case, changing the absorptive material to have a low absorptance provides a bright state by reflection from the background layer, and changing the absorptive material to have a high absorptance provides a dark state. The background layer 4 may have a uniform reflectance spectrum, (i.e. white), or may have a non-uniform reflectance spectrum (i.e. coloured), so that it absorbs incident light of some wavelengths (i.e. remains partially absorptive) but reflects light of other wavelengths, and so may change the perceived colour. This is known in itself for a reflective display device employing absorptive material for use as a display screen.

The background layer 4 may have uniform optical properties across its area, for example appearing as shown in FIG. 7.

Alternatively, the background layer 4 may have varying optical properties across its area, at the choice of the designer to vary the appearance of the decorative panel 1. For example, FIG. 8 shows a possible form of the background layer 4 in which it bears a broken pattern. The main aim of having a background in which the reflectance varies is to break up large areas of one colour into a series of grey levels. The end result is that they appear similar to areas of different depth or height as depicted on maps as contoured areas.

The reflection properties of the background layer 4 may be adjusted so that to reflect a colour with different reflectance values. This changes not only the background colour hue but also the hue of the combined colours (reflection from reflective layer and background). Thus it is possible to print patterns of one colour having different reflectances and so provides a background showing different grey levels both on its own and in combination with the liquid crystal. This feature is particularly effective at breaking up large areas of the same colour and adding further interest to the changeable image.

This effect can be realised by either printing the same colour with different hues (or reflectance) or using a transparent filter (e.g. a blue transparent filter) and placing behind this on a background printed with white and grey areas having different reflectance values.

Alternatively, to provide a specular appearance background layer 4 may be formed by a specular reflector behind a transparent grey filter which has areas of different transmission to modulate the appearance.

In summary, the overall appearance of decorative panel 1 is affected by the foreground image carried by the transparent front substrate 2, the reflective display device 3 and the background layer 4. These elements may in general be designed under the creative control of the designer in order to provide a range of different appearances.

In this regard, the foreground image is designed to have parts that are at least partially transparent and through which the changeable colour effect of the reflective display device 3 and the background layer 4 can be seen. The reflective display device 3 may be designed to change such that the overall appearance of the decorative panel 1 is changed in line with the desires of the viewer. For example, a change of mood, tone or ambience can be created by a change in colour or reflectivity. Because of the foreground image, the change does not provide colour change across the entire decorative panel (like changing a wall paint colour), but more subtle changes that involve part of an image. Also, changing the reflectance or absorptance level (grey levels) of the reflective or absorptive layer is very desirable as this allows a useful variation depending on the ambient light levels which change during the day.

The ability to provide grey levels within the areas that change colour is also desirable. Otherwise, large sections of coloured area will monotonically change and not look natural (in stone effects for example). Thus provision to create texture within these areas is important and can be done by printing the background or the foreground with areas of different reflectance or transmission respectively.

Although the design of the decorative panel 1 is under the control of the designer, one possible method for designing the foreground image to have the appearance of stone or wood is as follows.

A digital image is taken by a digital camera of stone or wood, for example a marble slab. This contains data on the very many light levels their colours and their locations that make up the appearance of the marble. These can be accessed and manipulated using image processing software, for example Photoshop, giving an histogram of how many pixels exhibit a particular light level. The foreground image is derived from the digital image, but the pixels of the images may be adjusted, based on an analysis of the histogram. This allows selection of parts of the image that should be transparent and indeed how transparent they are. For example, some pixels will be of very low reflectance (essentially black) while others will be very reflective. The low reflectance areas provide an ideal area that can be changed to another colour using the reflective display device 3. Many options are possible, making a selection defined by reference to the histogram of the light level of the image and defining the location of the pixels and their digital value (reflectance). Some possible options are as follows.

The reflective display device 3 described above including a liquid crystal layer 11 of cholesteric liquid crystal material, when fully switched into is bright state (planar) will reflect a certain level of light of a particular wavelength, the peak spectral reflectance being in the region of 30-40%. Its brightness as perceived by the viewer will vary due to the eye's sensitivity at different wavelengths. In a first option, those areas of the digital image whose reflectance is similar to and below the reflectance of the changeable material when showing its full reflectance can be defined and made totally transparent such that when printed onto the glass these defined regions do not have any printed ink on them. Thus they will allow full optical access to the reflective display device 3 behind the foreground image. In these parts, the viewer will perceive the combined effect of the reflective display device 3 and the background layer 4.

In a second option, the area to be fully transparent is defined by area, for example all areas with a reflectance below a certain value that allows a predetermined percentage, for example 20%, of the whole area to be fully transparent. This percentage can be changed depending on the image and colour of the reflective display device 3 and individual appearance, but typically might be at least 5%, preferably at least 15% and/or at most 60%, preferably at most 35%.

The first and second options may be combined.

A third option is that areas that are bright in the digital image can be made transparent in the foreground. For example by using a cholesteric display in its white to blue mode (this occurs when the background colour of the display is blue and an orange liquid crystal is used) or other two colour mode such as red/yellow or pink/beige etc. Typically the white reflection has a brightness of about 20-25%. Those areas of the foreground image with a white reflectance similar to that of the white of the cholesteric liquid crystal material are left open such that when the cholesteric liquid crystal material is placed behind the display it can be changed from white to blue thus adding some colour to an otherwise white area. Once again how much of the area corresponding to this reflectance is left fully transparent can be defined by the designer by defining in some detail the reflectance cut off value but typically might be at least 5%, preferably at least 15% and/or at most 60%, preferably at most 35%. The white/blue cholesteric liquid crystal material can be replaced by other colours such as white/magenta or yellow magenta.

A fourth option is for the foreground image to be printed with mainly transmissive inks (to give fixed grey levels) and only a small area having opaque inks so that the majority of the panel is changeable.

In foreground images having relatively large parts that are fully or partially transparent, the creation of one large single reflectance level area may appear unattractive or unnatural. Therefore different reflectance levels can be created in this area. This can be done in various ways.

A first option is to pixelate the reflective display device 3 so that different areas thereof can be driven to different light levels but increases the complexity of the reflective display device 3, or if the reflective display device 3 is specifically designed for that image then many different reflective display device 3 designs are needed.

A second option is to print within the transparent areas of the foreground image with transparent inks that have different transmission values that moderate the light getting through to the reflective display device 3 and thus lower the reflection level in these areas and provide the grey levels of the original image. As the grey level used in the reflective display device 3 increases (becomes brighter), these areas will become more noticeable. Inevitably due to some degree of light scattering in the transparent inks they will also reflect some light so even against a black background will give some grey level. Their transmission is defined by the designer and will be defined such that they lie in reflectance below the cut off value and above the lower reflectance value. Thus a neutral grey ink is printed in accordance with the image contours of the original image (or these could be enhanced or created if required). These transparent areas can be coloured, rather than neutral. In that case, they will reflect either their own colour (even if the background is black due to light scattering) or a combined colour of the transparent ink and the changeable colour of the reflective display device 3. This refinement adds interest and subtlety to the overall image and overcomes having large areas of single colour.

A third option is to form the background layer 4 such that it has different grey levels of the background colour, these modify the reflectance from the cholesteric liquid crystal and also by themselves (when the reflective display device 3 is in the clear state) provide a non-uniform reflectance area. For example images showing sea, clouds or rivers can be switched between blue and grey or white and other regions can be switched between other colours (if the cell is subdivided).

The light level or reflectance of the changeable colour can be varied by choosing to drive reflective display device 3 into a grey level. At its full reflectance, the colour effect is maximised and gives a surprising and interesting appearance. In some cases and in some ambient light levels a more subtle colour may be desired in which case a grey level can be chosen.

The simplest option is for all the area of the decorative panel 1 to change at the same time, so reflective display device 3 may consist of essentially one pixel the size of the decorative panel 1. For driving and power reasons this single pixel can be subdivided and all subdivisions driven together. In another option, reflective display device 3 can be subdivided into several areas (pixels) dependant on the design of the foreground image and each pixel changed independently to provide the appearance of a wave of colour moving across behind the image.

In another option, the reflective display device 3 can contain two or more areas of different colour which can be driven independently. In this case the liquid crystal layer 11 may be divided by glue seals into several areas, each area having its own filling hole which is used to inject the specific colour liquid crystal into that area. This is a known possibility for LCD manufacture, although rarely used in common practice. In this way several colours can be shown in the same panel in different areas.

In another option, the reflective display device 3 can consist of two cells 10. For example one cell 10 containing a blue liquid crystal and another cell 10 contains an orange liquid crystal. With a black background to the back of the two cells and the cells 10 laminated together the reflective display device 3 can be switched between white, black, blue and orange. Cells with other colour combinations can also be used as can more cells 10 in the stack such as red, green and blue cells 10, thus giving many colour combinations.

The decorative panel 1 may be affixed to a surface to decorate a surface. Non-limitative examples of such surfaces are as follows. The surface may be an interior or exterior surface of a building or other architectural structure. The surface may be a surface of a manufactured article, for example an item of furniture or a surface inside an automobile. A single decorative panel 1 may be used in isolation. In many applications, plural decorative panel 1 are tiled together to cover a surface of larger area than a single decorative panel 1, for example as is conventional for decorative tiles used in buildings. To facilitate tiling the decorative panel 1 may be rectangular, although it could in principle have any shape that tessellates, or there could be used together two or more decorative panels 1 of different shapes.

The decorative panel 1 may be affixed to a surface using any suitable means, optionally using location lugs on the surface to fix the location of the decorative panels 1.

Possibilities include mechanical fixings or magnets.

Another possibility is to bond the panel using an adhesive, for example of the type commonly used to affix ceramic or stone decorative tiles.

Another possibility is to use a mounting unit, for example a sheet or a frame. In this case, the mounting unit is affixed to the surface, by any suitable technique, for example by an adhesive or by a mechanical fixing such as screws or nails. Then, the decorative panels 1 are fixed to the mounting frame, for example by the mounting frame having sockets capable of mounting the decorative panels 1 or by using an adhesive.

The advantage of sockets is that they can locate the decorative panels 1, albeit at the expense of complicating the mounting unit. Furthermore, such sockets may also include an electrical connection. Such an electrical connection may supply power and/or control data to a control circuit 30 of the decorative panel 1. In this case, the decorative panel 1 includes a contact for the electrical connection of the socket that is connected to the control circuit 30. Alternatively, such an electrical connection may supply drive signals for changing the reflective properties of the reflective display device 3, in which case decorative panel 1 includes a contact for the electrical connection of the socket that is connected to the reflective display device 3 itself.

Another option, for use with a decorative panel 1 including a control circuit 30, is for the mounting frame to include inductive coils positioned to align with each respective decorative panel 1 for supplying power inductively to the control circuit 30. In this case, the control circuit 30 may include an inductive coil for receiving the power.

As an alternative to physical connections, control data may be supplied wirelessly to the control circuit 30, for example by IR (infra-red) or RF (radio frequency) signals. In this case, the control circuit 30 may include a wireless receiver for receiving the control signals. The control signals may originate from a control unit that is, for example, mounted on the surface or is a portable unit.

A possible construction for the decorative panel 1 that is intended to facilitate mounting is shown in FIG. 9 and will now be described.

In this construction, the reflective display device 3 comprises two cells 10 (although it could be one cell 10 or more than two cells 10), having the background layer 4 fixed to the rear side of the reflective display device 3. The decorative panel 1 comprises a control circuit 30 mounted to the rear side of the background layer 4 and connected to the reflective display device 3 by electrical tracks 20 extending across the rear side of the background layer 4 to the edges of the reflective display device 3. The control circuit 30 may be implemented in any suitable form typically including one or more printed circuits, that may include printed circuit boards (PCB) and flexible printed circuits (FPC) or a combination thereof.

The decorative panel 1 additionally comprises the following elements for protecting the reflective display device 3 and the control circuit 30. The decorative panel 1 comprises a spacer 21 being a wall that is shaped to extend around the periphery of the reflective display device 3. the spacer 21 may be made from polyvinyl chloride (PVC), that may be moulded or machined into shape. The spacer 21 is mounted to the transparent front substrate 2, accommodated by the transparent front substrate 2 having a slightly larger area than the reflective display device 3. The spacer 21 is taller than the height of reflective display device 3 and the control circuit 30. A rear protective sheet 22 is fixed to the spacer 21 to encase the reflective display device 3 and the control circuit 30. The rear protective sheet 22 may be hermetically sealed and/or have an aperture 23 aligned with the control circuit 30 for making an electrical connection therewith.

By way of example, some materials and dimensions of the elements of one possible embodiment of the decorative panel 1 are as follows:

transparent front substrate 2: glass, 3 mm thick, 175 mm square in area; reflective display device 3: 171 mm square in area;

spacer 21: plastic, e.g. ABS, that may be injection-moulded, or PVC, 2 mm width, 10 mm height; and

rear protective sheet 22: plastic, e.g. acrylonitrile butadiene styrene (ABS), that may be injection-moulded, or glass or ceramic, 3 mm thick, 175 mm square in area.

A possible implementation of the control circuit 30 is shown in FIG. 10 and will now be described.

The control circuit 30 comprises a microprocessor 31 that implements a control process to decide on the desired operation of the reflective display device 3. The control circuit 30 includes a wireless receiver 32 arranged to receive control signals wirelessly (e.g. by IR or RF) from an external control unit that allow the desired operation to be specified. Alternatively, control signals could be supplied over a wired control line. The received control signals are supplied to the microprocessor 31 which implements the control process on the basis thereof.

The control circuit 30 includes a driver circuit 33 that generates drive signals that are supplied to the reflective display device 3. The microprocessor 31 supplies a data signal representing the desired operation to the driver circuit 33 which generates the drive signals in response thereto.

The control circuit 30 also includes voltage level converter 34 that receives power from an external power supply 35 and generates a supply voltage of relatively low voltage that is supplied to the microprocessor 31 and to the wireless receiver 32 and a supply voltage of relatively high voltage that is supplied to the driver circuit 33.

As an alternative to the external power supply 35 being connected directly, the control circuit 30 may receive power by an inductive power source, for example of the type manufactured under the trade mark Powermat. In that case, the control circuit 30 may include an inductive coil to receive a 5.2V power supply.

An example of the decorative panel 1 has been manufactured as follows.

A transparent front substrate 2 was formed from 3 mm thick glass of size 150×150 mm with ground edges (to remove sharp edges) and an anti-glare (gloss 100) coating on the front surface.

A foreground image was printed on the rear surface of the transparent front substrate 2 using a UV curable ink. The printing machine was an Océ Arizona flatbed printer with Oce ijc 256 ink cartridges. The image file was derived from a scanned image of a piece of marble that had been modified by defining fully transparent areas within the image and boosting the image opacity around the edges to provide a high opacity border about 5-7 mm wide around the periphery of the transparent front substrate 2. The image file had 300 dpi resolution. The printed image was UV cured by the printing machine.

A reflective display device 3 of size 143 mm×143 mm was made with glass display substrates 12 and 13 having a 5 μm cell gap for the liquid crystal layer 11. The display substrates 12 and 13 were provided with a SE7511 (Nissan Chemicals) polyimide alignment layer and insulation layer. The cell gap was filled with MDA 003906 liquid crystal to give a blue display when in the planar state.

The electrode layers 14 and 15 were made from indium tin oxide. One of the electrode layers 14 and 15 was etched to divide it the into 5 equal size segments and the other was left as one large common electrode that covered all the active area of the reflective display device 3. The electrode layers 14 and 15 were connected to a control circuit 30 by flexible connectors.

The reflective display device 3 was laminated to the transparent front substrate 2 using either epoxy resin or UV curable adhesives. The rear of the reflective display device 3 was painted with a background layer 4 of black paint.

The transparent front substrate 2 was larger than the reflective display device 3, giving a 3 mm ledge that was fixed with epoxy resin to a spacer 21 machined from grey PVC. The rear protective sheet 22 was removable to allow access to the reflective display device 3 and its flexible connectors.

The flexible connectors were soldered to the control circuit 30 incorporating a voltage booster circuit that converted the 5V input to a maximum of 45V using a MAX 668 booster. No wires were used to connect the decorative panel to either the data or power supply on the mounting surface.

Power was provided by including an inductive coil system receiver in the control circuit 30, fixed into the rear of the case to provide 5V TO 5.5V and an inductive transmitter fixed into a fixing station fitted to a surface behind the decorative panel 1. The inductive receiver and transmitter were of the type manufactured under the trade mark Powermat. An 18v power supply was provided to the inductive transmitters from a mains transformer.

The microprocessor 31 was a programmable IC (for example PIC 16F722) that could be programmed to deliver, when commanded, a drive signal with voltages ranging from 5V to 45V and typically bipolar 100 ms pulses of 20V and/or 40V by which to change the reflectance of the liquid crystal from blue to black and black to blue. Several grey levels were also possible using pulsed voltages between 10V and 15V, all these states being stable over time.

The commands were provided to the microprocessor 31 using a hand-held RF transmitter that communicated with the wireless receiver 32 fixed to the control circuit 30. The reflective layer in the decorative panel 1 was changed by the RF commands to exhibit a blue or black colour and many other reflective levels of blue.

1. A decorative panel comprising:
a transparent front substrate carrying a foreground image, the foreground image having varying transparency across its area;
behind the foreground image, at least one layer of optically reflective or absorptive material which has a reflectance or absorptance that is changeable in response to an external stimulus and which transmits incident light that is not reflected or absorbed;
behind the at least one layer of reflective material, a background layer on which light transmitted by the at least one layer of optically reflective or absorptive material is incident and which is not transparent.

2. A decorative panel according to claim 1, wherein the foreground image includes parts that are fully transparent.

3. A decorative panel according to claim 1, wherein the foreground image includes parts that are partially transparent.

4-5. (canceled)

6. A decorative panel according to claim 1, wherein the foreground image is printed on the transparent front substrate.

7. A decorative panel according to claim 6, wherein the foreground image is printed on the rear of the transparent front substrate, or, in the case that the transparent front substrate comprises plural sheets, on an internal surface of a sheet.

8. (canceled)

9. A decorative panel according to claim 1, wherein the at least one layer of reflective or absorptive material is supported by at least one transparent display substrate.

10. A decorative panel according to claim 9, wherein the transparent front substrate is an additional substrate to said at least one transparent display substrate.

11. A decorative panel according to claim 1, wherein the at least one layer of reflective or absorptive material is sealed between two transparent display substrates by a peripheral seal.

12. (canceled)

13. A decorative panel according to claim 1, wherein the at least one layer of reflective or absorptive material has a reflectance or absorptance that is uniform across its area.

14. A decorative panel according to claim 1, wherein the at least one layer of reflective or absorptive material has areas that have reflectances or absorptances that are independently changeable in response to an external stimulus.

15. A decorative panel according to claim 1, wherein the at least one layer of reflective or absorptive material has a reflectance or absorptance spectrum that is non-uniform.

16. A decorative panel according to claim 1, wherein the at least one layer of reflective or absorptive material has a reflectance or absorptance that is changeable to more than two different levels.

17. A decorative panel according to claim 1, wherein the optically reflective or absorptive material is optically reflective material.

18. A decorative panel according to claim 16, wherein the optically reflective material is cholesteric liquid crystal material.

19. A decorative panel according to claim 17, wherein the background layer is absorptive.

20. A decorative panel according to claim 17, wherein the background layer is reflective.

21. (canceled)

22. A decorative panel according to claim 1, wherein the optically reflective or absorptive material is optically absorptive material.

23. (canceled)

24. A decorative panel according to claim 1, wherein the background layer has varying optical properties across its area.

25. A decorative panel according to claim 1, wherein said external stimulus is an electrical signal.

26. A decorative panel according to claim 25, further comprising a control circuit arranged to provide to the at least one layer of reflective or absorptive material an electrical signal capable of changing the reflective properties of the at least one layer of reflective material.

27. A decorative tile according to claim 24, wherein the background layer has varying reflectance or absorptance across its area.

28. A decorative tile according to claim 24, wherein the background layer is colored.

29. A decorative tile according to claim 24, wherein the background layer is arranged to reflect a color with varying reflectance across its area.
